(19) United States
(12) Patent Application Publication
(10) Pub. No.: US 2018/0040005 A1
(43) Pub. Date: Feb. 8, 2018

(54) VISIT BIGDATA PROCESSING SYSTEM USING BEACON AND METHOD FOR PROCESSING THEREOF

(71) Applicant: ARAM Solution Co., Ltd., Jeonju (KR)

(72) Inventors: Jun LEE, Jeonju (KR); Ju Hyun Lee, Jeonju (KR); Yun Jeong Lee, Jeonju (KR)

(21) Appl. No.: 15/372,613

(22) Filed: Dec. 8, 2016

(30) Foreign Application Priority Data
Aug. 5, 2016 (KR) 10-2016-0099798

(51) Int. Cl. G06Q 30/02; H04W 40/24; H04W 4/02

(52) U.S. Cl. CPC G06Q 30/0201; H04W 4/021; H04W 40/244

(57) ABSTRACT

Provides are a visit big data processing system using a beacon and a method therefor. According to the visit big data processing system and the method for processing the visit big data processing system, when a consumer visits a visiting place, a number of visits is automatically calculated and managed to figure out interest of the visiting place and thus provide visitor information and visiting place information that the consumer wants to know, and the information may be utilized for various marketing fields.

### CROSS-REFERENCE TO RELATED APPLICATIONS

This application claims priority from Korean Patent Application No. 10-2016-0099798, filed on 5, Aug. 2016, which is hereby incorporated by reference for all purposes as if fully set forth herein.

### BACKGROUND OF THE INVENTION

### 1. Field of the Invention

The present invention relates to a visit big data processing system, and more particularly, to a visit big data processing system using a beacon which is equipped in a visiting place to automatically calculate a number of visits for a visiting place by utilizing a beacon which detects a position of a visitor from a mobile terminal which is held by the visitor, configures big data using the number of visits for the visiting place which is calculated by the beacon, and statistically analyzes the big data to provide information on the visitor and the visiting place for various fields, such as a gender, a region, an age, a job, an interest, and a field, and configures a server to figure out an interest in the visiting place therethrough, to be utilized for marketing in various fields and a method for processing thereof.

### 2. Description of the Related Art

Currently, one of methods which are the most frequently used for marketing in various service fields is blog marketing. However, recently, reliability of customers for the blogs is lowered and thus the marketing effect is not so good. Therefore, it is required to present statistical data which is reliable and desired by the consumers. A problem of the blog marketing is that the blog is configured by an experiential group and the experiential group receives cash or goods from an advertiser so that many of blogs are related with a reward.

An ICT convergence technology is commercialized with respect to a government, research organizations, and industries so that IT based corporations in domestic and foreign countries provide various management marketing services based on a location recognizing technique. A location based service (LBS) is being grown along with a smart phone market and is prospected to expand to a convergence platform in which location information, commerce, and entertainment are combined.

In the meantime, a concept of a smart shopping through convergence of a mobile technique and a management marketing model appears and necessity of a shopper marketing model service is gathering strength.

In order to realize the smart shopping, a center of an enterprise marketing strategy is changed from consumer marketing which focuses on psychological change of a customer to shopper marketing which focuses on a behavior in a shopping place so that various information services based on locations of a user are provided. A service providing company simultaneously uses customer information (big data), location information of a customer which is generated in a store, and other information to build a shopper marketing model.

Through the realization of shopper marketing, convenience of the user is improved and sales of a related service company are grown and a brand asset thereof is increased. Further, a new blue ocean market is created to enter a small and medium industry and create employment, so that technical development is urgently needed. Specifically, an intelligent location estimating technique utilizing industry is a core foundation industry of various IT convergence services in the future and industrial utilization thereof may result in a high synergy effect not only in the smart shopping but also at various aspects of the management marketing.

Further, in recent years, an area of internet of things (IoT) called a future food and a core of a trend has expanded. In particular, there is a trend that as a smart phone is supplied, personalization of IT is diffused, and as a result, various contents have been released through linkage with various home appliances and various smart devices.

In recent years, Bluetooth smart, the mobile device or the smart device which supports Bluetooth low energy (BLE) can transmit information among devices without performing the pairing process and since a period of transmitting data is longer than that in the existing Bluetooth scheme, the power consumption is relatively small.

Further, a manufacturing cost of the mobile device is low so that the mobile device may be used as a Bluetooth beacon which provides various information for various purposes.

The Bluetooth beacon may be installed at a desired place and may be easily accessed through a mobile device or a smart device which supports Bluetooth which may be used without performing a pairing process and may be utilized in various fields as various information provided from the Bluetooth beacons at the installation places.

### RELATED ART DOCUMENT

### Patent Document

Korean Patent Registration No. 10-1579968 (firm date: Dec. 23, 2015).

Korean Patent Registration No. 10-1587888 (firm date: Jan. 22, 2016)

Korean Patent Unexamined Publication No. 10-2016-0026739 (Published date: Mar. 9, 2016)

Korean Patent Unexamined Publication No. 10-2015-0120887 (Published date: Oct. 28, 2016)

### SUMMARY OF THE INVENTION

An object of the present invention is to provide a visit big data processing system using a beacon to automatically calculate a number of visits for various visiting places and a method of processing thereof.

Another object of the present invention is to provide a visit big data processing system which automatically calculates the number of visits for a visiting place using a beacon, makes information of a visitor and the visiting location therethrough as big data to provide various information to be utilized for marketing and a method of processing thereof.

According to an aspect of the present invention, the visit big data processing system automatically calculates a number of visits for a visiting place by using beacons which are provided in various visiting places, configures big data using the calculated position information and the number of visits, and statistically analyzes the big data to provide information on the visitor and the visiting place for various fields. As described above, according to the visit big data processing system of the present invention, when the consumer visits a visiting place, the number of visits is automatically calculated and managed to figure out an interest in the visiting place and provide visitor information and visiting place information on the visiting place that the consumer wants to know about therethrough.

According to another aspect of the present invention, a method for processing a visit big data processing system includes: installing one beacon in which identification information recognized by a mobile terminal is stored in various visiting places, registering and managing the identification information for each beacon, and registering and managing the mobile information on each of the mobile terminals, by a visit big data processing server, automatically activating an application installed in the mobile terminal when the mobile terminal located in the visiting place recognizes the beacon through a wireless communication network, receiving the identification information from the recognized beacon through the wireless communication network, and counting a number of visits for the visiting place; transmitting the identification information corresponding to the beacon recognized by the mobile terminal through the wireless communication network and the counted number of visits to the visit big data processing server; receiving, collecting, and storing the identification information and the number of visits for various visiting places from the plurality of mobile terminals through the wireless communication network, by the visit big data processing server; and providing information on the visitor and the visiting place to be utilized for various marketing fields by calculating a total number of visits for the visiting places from the big data to generate big data by the visit big data processing server and statistically analyzing the big data.

As described above, according to the present invention, the visit big data processing system automatically calculates a number of visits for a visiting place by using beacons which are provided in various visiting places, configures big data using the calculated position information and the number of visits, and statistically analyzes the big data to provide information on the visitor and the visiting place for various fields, thereby figuring out an interest for the visiting place, and providing visitor information and visiting place information on the visiting place which are desired by the user, to be utilized for marketing in various fields.

Further, according to the present invention, the visit big data processing system automatically figures out a place where the customer visits using a beacon, so that there is no need to input the visiting place for receiving a reward, unlike the bloggers and there is no need to separately execute the application. As a result, the users may conveniently use the system.

### BRIEF DESCRIPTION OF THE DRAWINGS

FIG. 1 is a block diagram illustrating a network configuration of a visit big data processing system according to the present invention;

FIG. 2 is a block diagram illustrating a configuration of a beacon illustrated in FIG. 1;

FIG. 3 is a block diagram illustrating a configuration of a mobile terminal illustrated in FIG. 1;

FIG. 4 is a block diagram illustrating a configuration of a visit big data processing server illustrated in FIG. 1; and

FIG. 5 is a flowchart illustrating a processing sequence of a visit big data processing system according to the present invention.

### DETAILED DESCRIPTION OF THE PREFERRED EMBODIMENT

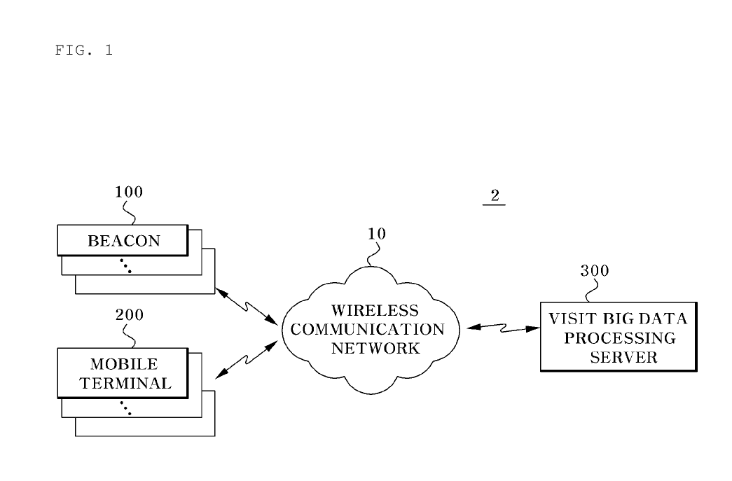

Hereinafter, an exemplary embodiment of the present invention will be described in detail with reference to FIGS. 1 to 5.

Referring to FIGS. 1 to 4, the visit big data processing system 2 of the present invention automatically calculates the number of visits for a visiting place using a beacon 100 equipped in various visiting places, builds big data using the calculated position information and number of visits and statistically analyzes the big data to provide information on a visitor and a visiting place for various fields.

When a customer visits various visiting places such as a restaurant, a store, a lodging, a tourist attraction, a museum, a zoo, and the like, the visit big data processing system 2 of the present invention automatically calculates and manages the number of visits to figure out an interest in the visiting place and provides various information about visiting place, for example, including visitor information and visiting place information for a sex, an age, a job, a region, a field, and an interest of the visitor that the consumer wants to know. Further, the visit big data processing system 2 allows the consumer to utilize the information for marketing.

To this end, the visit big data processing system 2 of the present invention includes a wireless communication network 10, a plurality of beacons 100, a plurality of mobile terminals 200, and a visit big data processing server 100.

The wireless communication network 10 is equipped with Bluetooth, WiFi, a mobile communication network, and the like. The wireless communication network 10 connects the plurality of beacons 100, the plurality of mobile terminals 200, and the visit big data processing servers 300 to each other. In this exemplary embodiment, the beacons 100 and the mobile terminals 200 are connected through the wireless communication network 10, for example, a Bluetooth communication network. The mobile terminals 200 and the visit big data processing servers 300 are connected through the wireless communication network 10 such as a mobile communication network, Bluetooth, and WiFi.

Each beacon is provided in various visiting places such as a restaurant, a lodging, a store, a tourist attraction, a museum, a zoo, and the like. In order to prevent the mobile terminal 200 from double counting the number of visits, the beacon 100 is provided in a specific location (for example, a counter). The beacon 100 has a predetermined wireless communication range. The beacon 100 is provided to automatically count the number of visits when a customer having the mobile terminal 200 enters the visiting place at first. To this end, the beacon 100 stores different identification information and position information according to the visiting place. When the mobile terminal 200 is recognized, the beacon 100 transmits the identification information and the position information to the mobile terminal 200 through the wireless communication network 10.

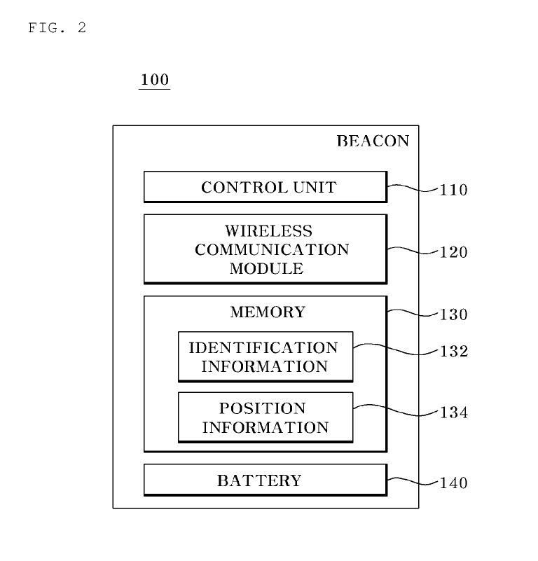

In the exemplary embodiment, the beacon 100 includes a control unit 110, a wireless communication module 120, a memory 130, and a battery 140, as illustrated in FIG. 2.

Specifically, the control unit 110 controls an overall operation of the beacon 100 to be processed. That is, the control unit 110 controls the wireless communication unit 120, the memory 130, and the battery 140. When the mobile terminal 200 recognizes the beacon 100, the control unit 110 controls the beacon 100 to read the identification information 132 and the position information 134 from the memory 130 to transmit the identification information 132 and the position information 134 to the mobile terminal 200 through the wireless communication module 120. The wireless communication module 120 is provided as for example, a Bluetooth module and is controlled by the control unit 110 to transmit the identification information 132 and the position information 134 to the outside through the wireless communication network 10. In the memory 130, the identification information 132 which is provided to allow the mobile terminal 200 to discern the beacon 100 and position information 134 on the visiting place are stored. The battery 140 is provided as for example, a primary battery, a rechargeable secondary battery, and the like and is controlled by the control unit 110 to supply driving power of the beacon 100.

The mobile terminal 200 is provided as for example, a portable electronic device such as a smart phone, a tablet phone, or a tablet PC and is held by a consumer who visits various visiting places. The mobile terminal 200 receives the identification information and the position information from the beacon 100 through the wireless communication network 10 using an application 232 to calculate a number of visits and transmits the identification information and the number of visits to the visit big data processing server 300 through the wireless communication network 10. When the beacon 100 is recognized, the mobile terminal 200 may collect various information from the beacon 100 without performing a pairing operation.

Further, the mobile terminal 200 requests to search and check various information on the visiting place from the visit big data processing server 300 using an application 232.

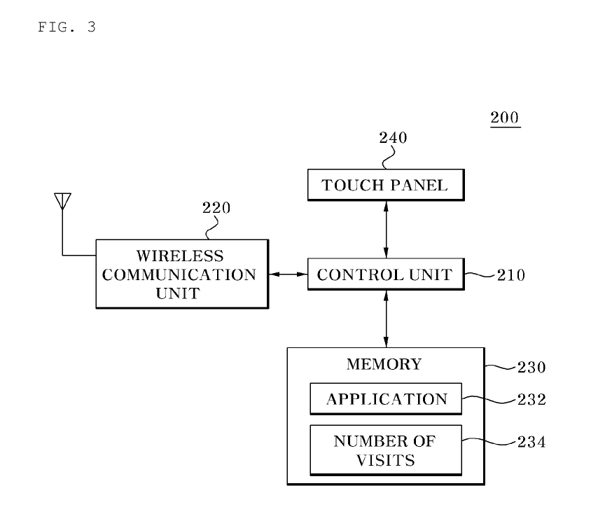

In the exemplary embodiment, the mobile terminal 200, as illustrated in FIG. 3, includes a control unit 210, a wireless communication unit 220, a touch panel 240, and a memory 230 in which the application 232 is installed.

The control unit 210 controls an overall operation of the mobile terminal 200 to be processed. That is, the control unit 210 controls the wireless communication unit 220, the touch panel 240 and the memory 230. When a beacon 100 of a specific visiting place is recognized, the control unit 210 automatically activates the application 232 and controls a function of the application 232, for example, to calculate the number of visits for the visiting place.

The wireless communication unit 220 is connected to the wireless communication network 10 by being controlled by the control unit 210 to process mutual data communication with the beacon 100 and the visit big data processing server 300. When the beacon 100 is recognized, the wireless communication unit 220 receives identification information and position information from the beacon 100 through the wireless communication network 10. The wireless communication unit 220 transmits the identification information, the position information, and the number of visits to the visit big data processing server 300 through the wireless communication network 10. The touch panel 240 displays various user interfaces of the application 232 and inputs various information to the user interfaces of the application 232.

The application 232 downloaded from the visit big data processing server 300 or an application market is installed in the memory 230. When the beacon 100 is recognized, the application 232 is automatically executed to be activated. The application 232 calculates the number of visits for the visiting place by receiving the identification information and the position information from the beacon 100 and transmits the identification information, the position information, and the number of visit to the big data processing server 300. In this case, when one beacon 100 for one visiting place is recognized, the application 232 is set so as not to count the same beacon 100 for a predetermined time so that the number of visits for the visiting place is not double counted.

The visit big data processing server 300 receives the identification information and the position information of the beacon 100 corresponding to the visiting place, and the number of visits from the plurality of mobile terminals 200 to construct big data for each visiting place and statistically analyzes the big data to provide various information to the mobile terminal 200. Therefore, instead of inputting evaluation and contents by a blogger or an experiential group who visits the visiting place, the visit big data processing server 100 automatically calculates and manages the number of visits when the customers visit the visiting place and process statistical analysis together with the user information of the mobile terminal 200 to generate big data and extracts and provides various informations such as the sex, the age, the job, a class, the field, and the interest of the visitor of the visiting place through the big data to figure out the interest in the visiting place.

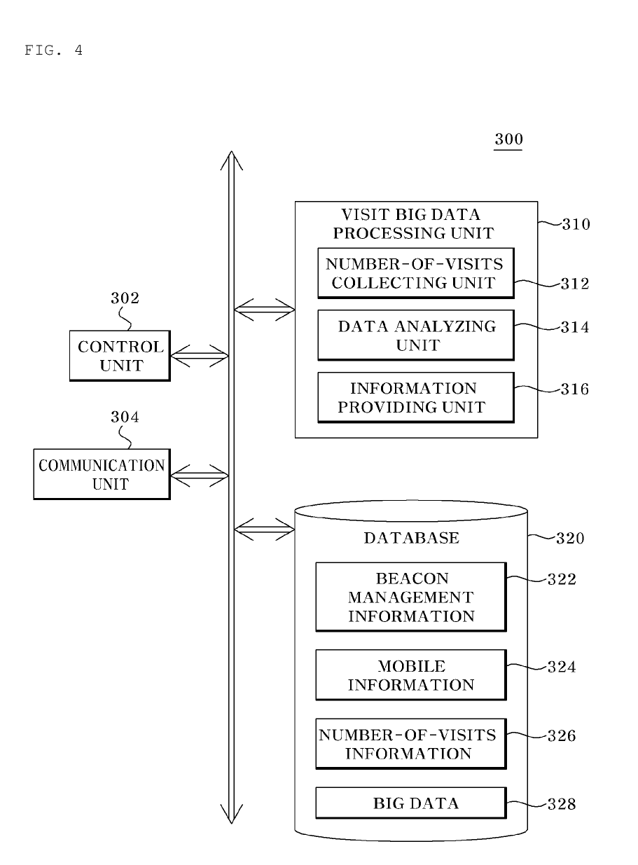

The visit big data processing server 300 of the exemplary embodiment, as illustrated in FIG. 4, includes a control unit 302, a communication unit 304, a visit big data processing unit 310, and a database 320. Further, although not illustrated, the visit big data processing server 300 includes components of a typical computer system, for example, a central processing device, a memory device, an input/output device, a storage device, and the like.

Specifically, the control unit 302 controls an overall operation of the visit big data processing server 300 to be processed. That is, the control unit 302 controls the communication unit 304, the visit big data processing unit 310, and the database 320. In addition, although not illustrated, the control unit 302 may include software such as an operating system program and a control program as well as hardware such as the central processing device, the memory or a web server.

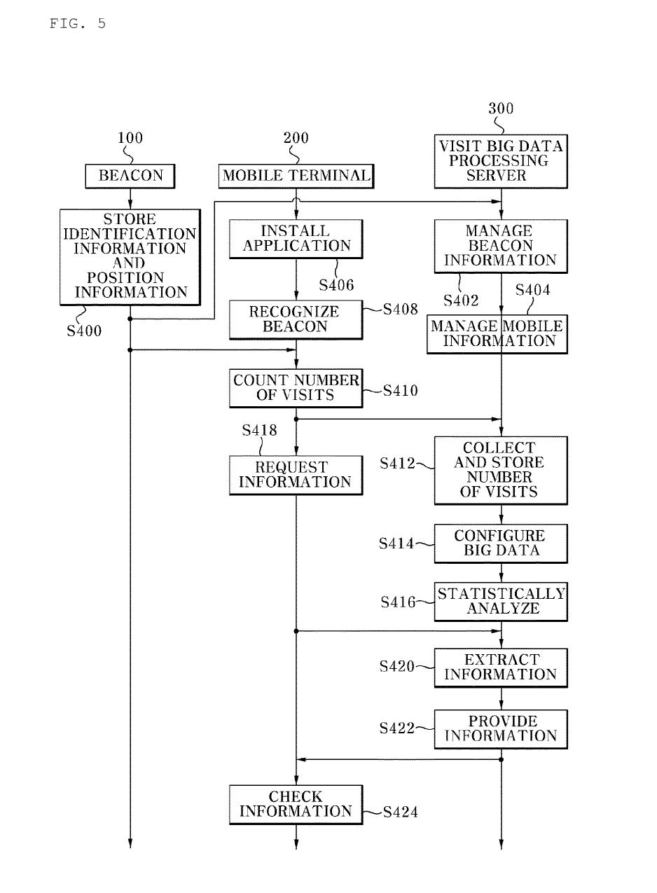

The control unit 302 controls the visit big data processing unit 310 to collect visiting place information transmitted from the mobile terminal 200 through the wireless communication network 10 and generates big data through the collected visiting place information. The big data generated as described above is statistically analyzed as information on the visiting place and the visitor to be utilized for services in various fields, for example, marketing for promotion, advertisement, and business. Detailed processing contents for the control unit 302 and the visit big data processing unit 310 will be described in detail in FIG. 5.

The communication unit 304 is connected to the beacon 100 and the visit big data processing server 300 through the wireless communication network 10 by being controlled by the control unit 302 to process the mutual data communication to receive identification information and the position information from the beacon 100 and transmit the identification information, the position information, and the number of visits to the visit big data processing server 300.

When the mobile terminal 200 recognizes the beacon 100 of a specific visiting place through the wireless communication network 10, the visit big data processing unit 310 provides the application 232 which is automatically activated and receives the identification information and the position information of the beacon 100 installed in the visiting place and the number of visits for the visiting place from the mobile terminal 200 using the application 232 to calculate the number of visits for the visiting place, and statistically analyzes the identification information, the position information, the number of visits, and user information of the mobile terminal 200 to generate big data, and extracts the big data in which information requested in the mobile terminal 200 is included.

The visit big data processing unit 310 of the exemplary embodiment includes a number-of-visits collecting unit 312 which receives the identification information and the position information on the specific visiting place, and the number of visits from the mobile terminal 200 through the wireless communication network 10 to collect the information on the plurality of visiting places to automatically calculate the number of visits for the visiting place, a data analyzing unit 314 which statistically analyzes the data on the number of visits to generate big data, and an information providing unit 316 which extracts information on the desired visiting place of the mobile terminal 200 from the big data (for example, various information on the visitor and the visiting place for a region, an age, a sex, a job, an interest, and a field) to be provided.

The database 320 stores various information according to the processing process of the visit big data processing unit 110 by being controlled by the control unit 302. In the exemplary embodiment, the database 320 is equipped in the visit big data processing server 300, but may be equipped as a separate database server.

The database 320 of the exemplary embodiment stores beacon management information 322 including the identification information and the position information of the beacon, the visiting place information on an installation location (for example, a restaurant, a store, and a lodging) of the beacon, mobile information 324 including the user information (for example, a sex, an age, a region, a job and the like) of the mobile terminal 200 and identification information of the mobile terminal 200, number-of-visits information 326 including a number of visits for the visiting place transmitted from the mobile terminal 200, and big data 328 generated by statistically analyzing the beacon management information 322, the mobile information 324, and the number-of-visits information 326.

As described above, the visit big data processing system 2 of the present invention automatically calculates the number of visits using the beacon 100 installed in various visiting places, builds the big data therethrough, and provides various information on the visitor and the visiting place from the big data, to be utilized for a marketing material in various service fields.

FIG. 5 is a flowchart illustrating a processing sequence of a visit big data processing system according to the present invention. This sequence is a program by which the beacon 100, the mobile terminal 200 and the visit big data processing server 300 are interlinked to each other and is processed by the application 232 and the visit big data processing unit 310.

Referring to FIG. 5, in the visit big data processing system of the present invention, one beacon 100 is installed for every visiting place in step S400. In this case, the identification information which is recognized by the mobile terminal 200 and the position information of the visiting place are stored in the beacon 100.

In step S402, the visit big data processing server 100 registers and manages beacon information of each beacon 100, that is, the identification information and the position information. For example, when the beacon 100 is installed in a specific restaurant, if the beacon 100 is recognized by the mobile terminal 200, the visit big data processing server 100 receives the identification information and the position information from the mobile terminal 200 to discern the visiting place in which the beacon is currently installed as the specific restaurant through the identification information and discern the position information to figure out the position of the specific restaurant.

In step S404, the visit big data processing server 100 registers and manages the mobile information for every mobile terminal 200. In step S406, the mobile terminal 200 downloads the application 232 through the visit big data processing server or an application market to install the application therein. When the application 232 is installed in the mobile terminal 200, user information is transmitted through a member registration process and the identification information of the mobile terminal 200 is recognized to manage the user of the mobile terminal 200.

In step S408, when the mobile terminal 200 moves to be located in a specific visiting place and recognizes the beacon 100 through the wireless communication network 10 (for example, Bluetooth), the mobile terminal 200 automatically activates the application 232 in step S410.

In step S410, the mobile terminal 200 receives the identification information and the position information from the recognized beacon 100 to count the number of visits. In this case, the mobile terminal 200 sets a predetermined period (for example, 12 hours after counting the number of visits at first) or a calculation cycle (for example, two times per day) set so as not to double count the number of visits in one visiting place and counts the number of visits one time for the set period. Further, the mobile terminal 200 transmits the identification information and the position information corresponding to the beacon 100 recognized through the wireless communication network 10, and the number of visits to the visit big data processing server 300.

In step S412, the visit big data processing server 300 receives the identification information, the position information, and the number of visits for various visiting places from the plurality of mobile terminals 200 through the wireless communication network 10 to collect and store the information. In step S414, the visit big data processing server 300 generates and stores big data of various collected and stored information and in step S416, the big data is statistically analyzed to be extracted as various information.

In step S418, when the mobile terminal 200 requests the visit big data processing server 300 to search for desired information using the application 232, in step S420, the visit big data processing server 300 extracts the corresponding information from the big data and in step S422, provides the corresponding information to the mobile terminal 200 through the wireless communication network 10. Next, in step S424, the mobile terminal outputs the corresponding information through the application 232 to be checked.

Hereinabove, although the configuration and the action of the big data processing system according to the present invention have been illustrated according to the detailed description and the drawings, this is just described by using the exemplary embodiment and various changes and modifications can be made without a scope without departing from the technical spirit of the present invention.

What is claimed is:

1. A visit big data processing system, comprising:
a beacon which is installed in different visiting places and stores identification information corresponding to the visiting place;
a mobile terminal which is held by a visitor who visits the visiting place, automatically activates an application when the beacon is recognized through a wireless communication network, and receives the identification information from the beacon through the application to count a number of visits for the visiting place; and
a server which stores and manages information on the beacon and the mobile terminal to discern the visitor and the visiting place, receives and collects the identification information on the beacon and the number of visits from the plurality of mobile terminals through the wireless communication network to calculate a total number of visits for each visiting place to generate big data, and statistically analyze the big data to provide the information on the visitor and the visiting place to be utilized for various marketing fields.

2. The system of claim 1, wherein the server statistically analyzes the big data to provide at least information on the visiting place for a sex, an age, a job, a region, a field, and an interest of the visitor.

3. The system of claim 2, wherein the server includes a visit big data processing unit configured by:
a number-of-visits collecting unit which is interlinked with the application and receives the identification information and the number of visits for a specific visiting place from the mobile terminal through the wireless communication network to collect the information on the plurality of visiting places to automatically calculate the total number of visits for the visiting place;
a data analyzing unit which statistically analyzes the data on the total number of visits to generate big data; and
an information providing unit which extracts information on the visiting place from the big data to be provided.

4. The system of claim 3, wherein the application counts the number of visits a predetermined period later after counting the number of visits at first or sets a count cycle to limit the number of visits per day and counts the number of visits one time during the predetermined period or at a predetermined cycle so as not to allow the mobile terminal to double count the number of visits in one visiting place.

5. A method for processing a visit big data processing system, the method comprising:
installing one beacon in which identification information recognized by a mobile terminal is stored in various visiting places, registering and managing the identification information for each beacon, and registering and managing the mobile information on each of the mobile terminals, by a visit big data processing server,
automatically activating an application installed in the mobile terminal when the mobile terminal located in the visiting place recognizes the beacon through a wireless communication network, receiving the identification information from the recognized beacon through the wireless communication network, and counting a number of visits for the visiting place;
transmitting the identification information corresponding to the beacon recognized by the mobile terminal through the wireless communication network and the counted number of visits to the visit big data processing server;
receiving, collecting, and storing the identification information and the number of visits for various visiting places from the plurality of mobile terminals through the wireless communication network, by the visit big data processing server; and
providing information on the visitor and the visiting place to be utilized for various marketing fields by calculating a total number of visits for the visiting places from the big data to generate big data by the visit big data processing server and statistically analyzing the big data.

6. The method of claim 5, wherein in the counting of a number of visits for the visiting place, the number of visits is counted a predetermined period later after counting a number of visits at first or a count cycle is set to limit the number of visits per day and the number of visits is counted one time during the predetermined period or cycle so as not to allow the mobile terminal to double count the number of visits in one visiting place.

7. The method of claim 6, wherein in the providing of information on the visitor and the visiting place, the big data is statistically analyzed to provide at least information on the visiting place for a sex, an age, a job, a region, a field, and an interest of the visitor.
